(19) United States
(12) Patent Application Publication
(10) Pub. No.: US 2010/0220559 A1
(43) Pub. Date: Sep. 2, 2010

(54) Electromechanical Module Configuration

(76) Inventors: Louis M. Galie, Newtown, CT (US); Wolfgang Burkhardt, Ispringen (DE); Gerhard Stotz, Eisingen (DE); Hans G. Schnell, Karlsbad-Langensteinbach (DE); Roland Burghausen, Niefern (DE)

Correspondence Address: ARTHUR G. SCHAIER;CARMODY & TORRANCE LLP, 50 LEAVENWORTH STREET, P.O. BOX 1110, WATERBURY, CT, 06721, US

(21) Appl. No.: 12/394,459

(22) Filed: Feb. 27, 2009

(51) Int. Cl. G04B 19/02; G04D 99/00

(52) U.S. Cl. 368/220; 29/592.1

(57) ABSTRACT

A wearable electronic device for conveying information using one or more display indicators, wherein the electronic device comprises a housing; a nest positioned in the housing; a plurality of independently insertable and removable modules coupled to the nest, wherein each module comprises (i) a gearing arrangement comprising at least one rotateable gear and (ii) a stepper motor, the stepper motor comprising a rotor rotateably coupled to the at least one rotateable gear; a controller operatively coupled to the stepper motor of each module, for causing the rotation of the rotor of each module; wherein each of the plurality of modules has associated therewith and mechanically coupled thereto one or more display indicators; whereby the positioning of the one or more indicators conveys information by referring to particular indicia. In a specific embodiment, the wearable electronic device is a wristwatch.

### BACKGROUND OF THE INVENTION

This invention relates generally to wearable electronic devices, such as timepieces/wristwatches by example and not limitation, and in particular, to a wearable electronic device that incorporates a unique quartz analog movement construction and methodology therefor, which is microprocessor controlled, and which can accommodate multi-display indicator and multimotor movements.

The industry of wearable electronic devices is filled with attempts to improve the construction, functionality, versatility and aesthetic appearance of such wearable electronic devices, all the while being mindful of and trying to reduce the associated manufacturing costs thereof In fact, it is believed that ongoing attempts try to accomplish one or more of the foregoing, even sometimes simultaneously, by balancing device characteristics and components to be used therein.

It is well known that the prior art contains examples of watches that incorporate plastic movements, metal movements or sandwich movements. Typically, the location of the components is fixed directly between the frame and the bridge, or for more complicated movements, between multiple bridges. Undesirably, this can require that at least the mechanical portions of a movement must be completely assembled in one location, thus possibly reducing the efficiency in manufacturing capabilities if various manufacturing sites would have otherwise provided for improved efficiency and capabilities.

The present invention overcomes some of the deficiencies in the art by optimizing the manufacturing and construction of such wearable electronic devices. For example and not limitation, the present invention provides for the design and construction of functional “modules” comprising a motor and movement side wheels. These individual “modules,” which may be related to a particular function of a movement (QA portion, 4th hand driving unit, hour/minute, etc.), can then be assembled individually and independently of each other, independently of other components, and even possibly independent of the general movement assembly itself. These modules can thereafter all be brought together onto a preferably metal frame (e.g. “nest”), with electrical connections, as needed, to a printed circuit board (PCB).

Constructed in this manner, the present invention provides many and significant advances over the prior art, just some of which are (i) a high flexibility in design and functionality, (ii) use of optimum assembly capabilities such as the expertise of different manufacturing locations, (iii) the combination of advantages in the use of plastic and metal components and (iv) an improved assembly and disassembly process of the resulting products.

Still further advantages and objectives are both desired and achievable by the present invention and such improved construction, manufacturing and methodologies thereof and additional advantages and objectives, as set forth herein, are provided by the present invention.

### SUMMARY AND OBJECTIVES OF THE INVENTION

It is thus an objective of the present invention to overcome the perceived deficiencies in the prior art.

It is another objective and advantage of the present invention to provide an electronic device that can be efficiently made of both metal and plastic parts, and in particular, to utilize independently insertable and removable modules comprising a gearing assembly and a stepper motor, parts of which can be made of plastic, while other components of the overall device are made of metal.

It is yet another object of the present invention to provide an improved electronic device in which the functionality thereof can be easily modified, changed and/or enhanced.

Still another object of the present invention is to provide an electronic device assembly that reduces manufacturing costs, inventory costs and schedule time, as well as increases efficiency in manufacturing flexibility.

As but one example, the present invention permits and provides more efficient layout opportunities of the modules on the frame/nest. For example, the modules can be placed more efficiently (e.g. closer together) thereby maximizing space in/on the frame/nest. As but another example thereof, being able to make the modules in differing shapes permits the increased versatility in placement on/in the nest. As an aside, it should be understood that use of the phrase “on the frame (or nest) and “in the frame (or nest)” are both intended to mean the same thing, namely, that the modules are positioned as illustrated in the figures. The use of the terms “in” and “on” in this manner and in connection with the relationship between the modules and the frame/nest are intended and should be understood to be interchangeable.

And in particular, a few additional advantages and objectives of the present invention are to provide: (i) a means for interchangeability between “electroset” and mechanical setting capabilities; (ii) an improved way to mount the center post in a “nest” to permit flexibility of the center post placement; (iii) different gearing configurations with minimal motor reconfigurations; (iv) a means for ease of assembly and disassembly of the electronic device; (v) a means to easily modify and/or extend the functional features of the device without substantial modification to the module itself; (vi) a way to isolate the manufacture, repair and design of the mechanical assembly of the modules; (vii) testing of the motor and gearing of the modules before assembly in the movement itself; and (viii) a module in which the stator/coil core assembly is designed to reduce motor thickness and preserve stator/coil core contact area.

Yet another objective and advantage of the present invention is that, if desired, the weight of the electronic device can be reduced by the use of plastic parts.

Yet a further objective and advantage of the present invention is that friction can be reduced by the elimination of metal against metal, which will be obvious to those of ordinary skill in the art by the use of plastic as disclosed herein.

Yet still further, the present invention has the advantage that the locations of the modules can be easily changed by the simple changing of the nest configuration, such as by machining the frame/nest to reorient the modules. Also, as will be seen, the present invention will lend itself advantageously to the use of different modules in the same frame (thus leading to different functionality of the device without extensive modifications to the underlying frame/nest) and/or different module gearing notwithstanding the same module shape, which itself will also provide for increased setting and display designs and configurations without the need to change the frame/nest because all that may need to be changed is the gearing of the individual modules.

Still further, with for example, the flexibility in positioning of the modules of the present invention, 3-dimensional displays are readily achievable by the layering of the modules.

Moreover, the present invention also lends itself to configuring the “nest” in different shapes and at different angles, which provides for other interesting electronic device shapes and sizes.

Further, the present invention has for objectives and advantages that if desired, a single microcontroller can control many, if not all, of the modules. Also, to be sure, while in the preferred embodiments the modules are described as comprising a stepper motor and gears, it should be understood that the modules may also be comprised of a sensor, such as HR or other sensors, just to name an example.

Still other objects and advantages of the invention will in part be obvious and will in part be apparent from the specification.

The invention accordingly comprises the features of construction, combination of elements and arrangement of parts and sequence of steps which will be exemplified in the construction, illustration and description hereinafter set forth, and the scope of the invention will be indicated in the claims.

To carry out the advantages and objectives set forth above and below, the present invention, generally speaking, is directed to a wearable electronic device for conveying information using one or more display indicators, wherein the electronic device comprises a housing; a nest positioned in the housing; a plurality of independently insertable and removable modules coupled to the nest, wherein each module comprises (i) a gearing arrangement comprising at least one rotateable gear and (ii) a stepper motor, the stepper motor comprising a rotor rotateably coupled to the at least one rotateable gear; a controller operatively coupled to the stepper motor of each module, for causing the rotation of the rotor of each module; wherein each of the plurality of modules has associated therewith and mechanically coupled thereto one or more display indicators; whereby the positioning of the one or more indicators conveys information by referring to particular indicia.

Methods of constructing a wearable electronic device comprising the movement assembly set forth above are also disclosed.

For example, in a preferred embodiment, a method of manufacturing a wearable electronic device for conveying information using one or more display indicators, comprises the steps of assembling, in a first manufacturing location, a plurality of independently insertable and removable modules, each of which comprise (i) a gearing arrangement comprising at least one rotateable gear and (ii) a stepper motor, the stepper motor comprising a rotor rotateably coupled to the at least one rotateable gear; transporting the assembled independently insertable and removable modules to a second location; constructing the electronic device by at least performing the steps of (i) inserting the assembled independently insertable and removable modules into a housing and positioning the modules onto a nest; (ii) operatively coupling a controller to the stepper motors of each module, for causing the rotation of the rotor of each module; (iii) operatively coupling each of the plurality of modules to at least one display indicator, wherein the positioning of the one or more indicators conveys information by referring to particular indicia.

By reference to the first and second “locations” in the preceding paragraph, it is meant that such locations are physically distinct and not necessarily located in the same manufacturing plant. For example, the foregoing reference is meant to cover methodologies where by the modules are assembled in one country and transported to a second country for said insertion step. That is, a boat, plane or other commercial type transportation method may be required to do said transporting. In this way, at least many of the foregoing objectives and advantages may be carried out.

In the preferred embodiment, the electronic device has timekeeping functionality, and thus, in a specific embodiment, is a wristwatch.

### BRIEF DESCRIPTION OF THE DRAWINGS

The above set forth and other features of the invention are made more apparent in the ensuing Description of the Preferred Embodiments when read in conjunction with the attached Drawings, wherein:

FIGS. 1A, 1B and 1C illustrate several time telling configurations in accordance with the present invention;

FIGS. 2A, 2B and 2C illustrate both a time telling and date display configuration in accordance with the present invention;

FIGS. 3A, 3B and 3C illustrate a time telling, a date display configuration and a retrograde hand display configuration in accordance with the present invention;

FIGS. 4A, 4B and 4C illustrate a time telling and a time zone/alarm time configuration in accordance with the present invention;

FIGS. FIGS. 5A, 5B and 5C illustrate a time telling, a time zone/alarm time and a retrograde hand display configuration in accordance with the present invention;

FIGS. 6A, 6B and 6C illustrate a time telling, a time zone/alarm time and date display configuration in accordance with the present invention;

FIGS. 7A, 7B and 7C illustrate time telling, a time zone/alarm time, a date display and a retrograde hand display configuration in accordance with the present invention;

FIGS. 8A, 8B and 8C illustrate four motor examples of additional display configurations in accordance with the present invention;

FIGS. 9A, 9B and 9C illustrate five motor examples of additional display configurations in accordance with the present invention;

FIGS. 10A, 10B, 10C, 10D illustrate variants of a second time zone “eye” in accordance with the present invention;

FIGS. 11A, 11B and 11C illustrate examples of a wearable electronic device in the form of a wristwatch having a time-telling display, a date display, a retrograde hand and a moon phase display in accordance with the present invention;

FIG. 12 illustrates a wearable electronic device having a plurality of displays, not all of which would be typically contemplated to be simultaneously incorporated into such a device, but not because such a device cannot be achieved, as it can be achieved in accordance with the present invention in view of the versatility set forth herein, but rather because it would not be typical to have the particular and simultaneous placement of all the extensive number of hands, some of which would, in the normal design, interfere with one another (e.g. a contemplated seconds hand mounted on the center stem could collide and thus not rotate as it could be blocked by hands 12, 14). However, design adjustments could be made in accordance with the present invention if desired to achieve the design set forth in FIG. 12;

FIGS. 13A, 13B, 13C, 13D, 13E illustrate among other things, a module in accordance with the present invention;

FIGS. 14A and 14B illustrate a module in accordance with the present invention being used in connection with the driving of a second time zone minute and hour hand;

FIGS. 15A, 15B illustrate the use of a module in accordance with the present invention being used in connection with a second Time Zone and the display of a sun and moon function;

FIG. 16 illustrates a module in accordance with the present invention adapted for use in connection with a another Time Zone display;

FIGS. 17A, 17B, 17C illustrate a module in accordance with the present invention being used in connection with other configurations, such as for a North/South hemisphere true moon phase display or for a decade counter;

FIGS. 18A, 18B, 18C, 18D illustrate a module in accordance with the present invention used for driving a date ring;

FIGS. 19A and 19B illustrate a module in accordance with the present invention being used for driving one or more other display hands;

FIG. 20A illustrates a contemplated design in accordance with the present invention, showing five (5) modules on a nest for placement in the housing, and in particular, FIG. 20A illustrates a five (5) module electroset version of the present invention;

FIGS. 20B and 20C show a preferred nest in accordance with the present invention, illustrating one module of the present invention, and in particular, an electroset setting module;

FIG. 21 is another perspective view of a preferred module in accordance with the present invention;

FIG. 22A is an exemplary four module mechanical embodiment in accordance with the present invention, with a mechanical setting module all mounted on a nest of the present invention;

FIG. 22B is a close-up of the exemplary four module mechanical embodiment in accordance with the present invention, particularly highlighting the mechanical setting module;

FIG. 22C is similar to the construction of FIG. 22B with the mechanical setting module shown translucently (shadow) and the grey detent spring shown more clear as solid;

FIG. 22D is similar to FIGS. 22B and 22C and further shows the setting stem and the setting engagement for time setting (green wheel), for date setting (rouse wheel), with mechanical wheel stop spring (blue) and with electrical contact spring (yellow), which interfaces to signal the stem's position the microprocessor (e.g. backlighting EL mode, normal run, set 1 or set 2), along with the housing and parts therein shown by wireframe;

FIG. 23 is a partial block diagram of the electronic device of the present invention;

FIG. 24 illustrates a block diagram of controller 100 in accordance with the present invention; and

FIGS. 25, 26, 27, 28 illustrate an electronic device in accordance with the present invention in various stages of completion.

Identical reference numerals in the figures are intended to indicate like parts, although not every feature in every figure may be called out with a reference numeral.

### DESCRIPTION OF THE PREFERRED EMBODIMENTS

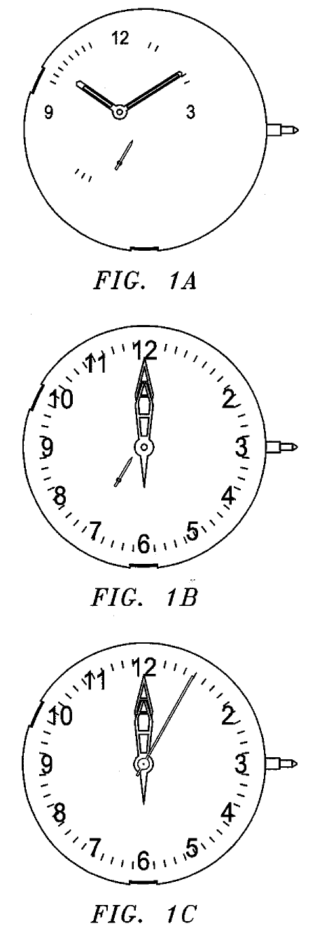

Reference is first made to FIGS. 1-11 in combination with the following, for a disclosure of just some of the functional capabilities achieved by the present invention. For example, the present invention provides for:

a. Time Telling: conventional time telling functions of a movement (hours, minutes, and seconds), with additional capabilities such as:
time shown in the “Glashütte position”
time shown with conventional center and off-center mounted hour, minute, and sweep second hands
optional sub-second capability
optional AM/PM indicator (sun/moon)
   b. Full analog second time zone, such as:
2-hand 12 or 24 hour indication of second zone
complete “world time zone” compatibility with ¼ hr, ½ hour and ¾ hour capability
interchangeable “home time” and “second time” in the primary time telling position
   c. Full analog alarm time indication, with:
2-hand 12 or 24 hour indication of alarm time second time zone alarm capability
optional Alarm on/off indication
accuracy to the second and adjustability to the minute
   d. Chronograph, with monopoussoir or dual pusher splits.
unidirectional center sweep
single hand or dual-hand “decade” display for minutes and hours
optional retrograde hour display
optional timer mode
   e. Perpetual Calendar, with:
full bidirectional perpetual calendar operation
optional day of week or month retrograde display
   f. Special Function bidirectional “eye,” for:
lunation with Northern/Southern hemisphere capability
tide display
equation of time display

It should be noted that the foregoing is by example and not limitation, as such functionality can be more or less configured together in any one wearable electronic device.

For example, in connection with a wearable electronic device in the form of a timepiece, the watch dial configurations of FIGS. 1-11 are indicative of just some of the combinations of possible functionality and dial/display configurations of the present invention. However, it should be understood that such examples are not the complete set of combinations which are possible, since the present invention is also capable of interfacing to sensors mounted in the device, thereby extending and expanding the functional capabilities of the device as well as providing the functionality described and suggested by the remaining figures.

As such, the electronic device of the present invention may be in the form of and/or have functionality related to altitude, temperature or compass measurements, barometric pressure, heart rate display, blood pressure (and/or combinations thereof), the display of tide information such as whether the tide is high or low, sunset information, moon phases, medical information such as when medicine should be taken and how many pills at each time interval, a count-down timer, or any one of additional parameters such as water pressure, water depth and oxygen left in a diver's tank (i.e. a diver's watch); object finder (i.e. to find one's car or way back to a starting location); blood/sugar levels (a glucometer); speed and distance (a runner's watch); displaying how much money is in a debit account; and any combination of the foregoing, all of which may be in addition to or in the absence of conventional timekeeping functionality.

Therefore, while in the preferred construction, the present invention is in the form of an electronic device, which may be a timepiece having the configuration and construction as set forth in any one of the figures, reference to selected figures will be made throughout this disclosure for exemplary embodiments, yet may comprise other features and parts, namely for example and not limitation, a wrist strap (not shown) for securing the electronic device to a wrist. Non-essential details of the present invention as well as examples of all of the foregoing embodiments can be found in coowned U.S. Pat. No. 7,113,450, the subject matter of which is fully incorporated by reference herein and especially at this moment for the purpose of disclosing the various embodiments above.

For example, FIGS. 1A, 1B and 1C illustrate several time telling configurations, which would typically require a minimum of two motors, as will be explained further below.

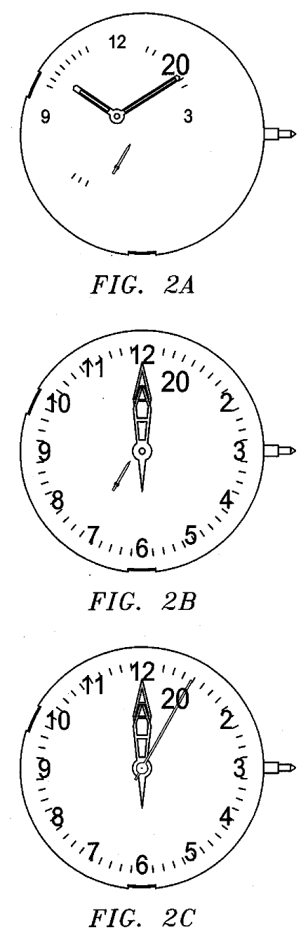

In another example, FIGS. 2A, 2B and 2C illustrate both a time telling and date display configuration (the date display configuration utilizing the construction as set forth in one or more of the following: U.S. Pat. Nos. 7,023,762; 7,027,361 or Published Application No. US 2006/0285445, the subject matter of each being incorporated by reference as if fully set forth herein for their disclosure of various date display constructions), which would typically require a minimum of three motors, as would be understood by those skilled in the art and further disclosed below.

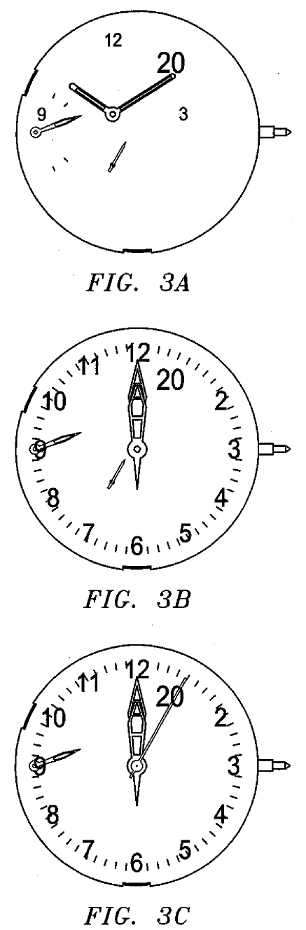

In yet another example, FIGS. 3A, 3B and 3C illustrate a time telling, a date display configuration and a retrograde hand (e.g. a day or month display), which would typically require a minimum of four motors, as also would be understood in the art.

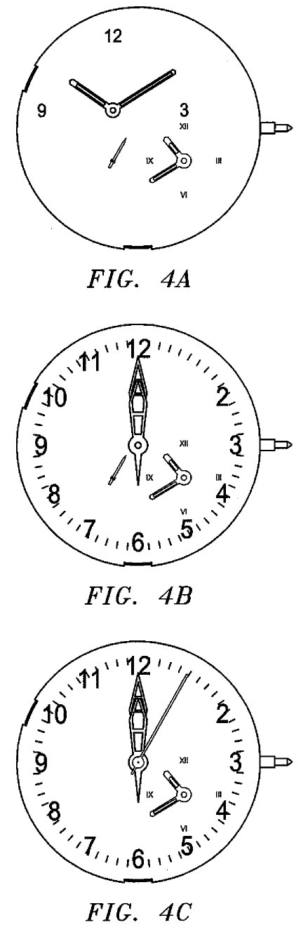

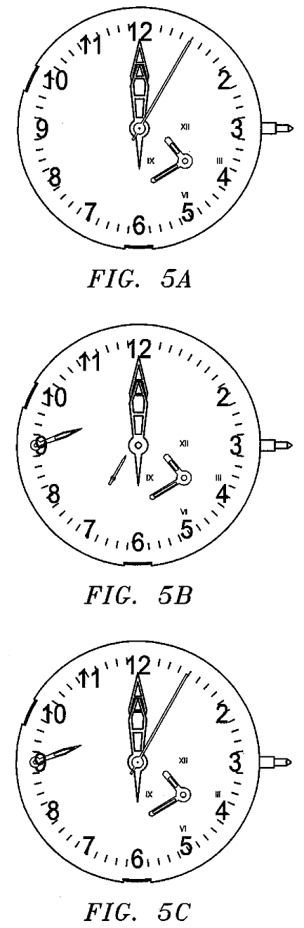

In still another example, FIGS. 4A, 4B and 4C illustrate a time telling and a time zone/alarm time configuration, which would typically require a minimum of three motors.

Similarly, FIGS. FIGS. 5A, 5B and 5C illustrate a time telling, a time zone/alarm time and a retrograde hand (e.g. a day or month display) configuration, which would typically require a minimum of four motors.

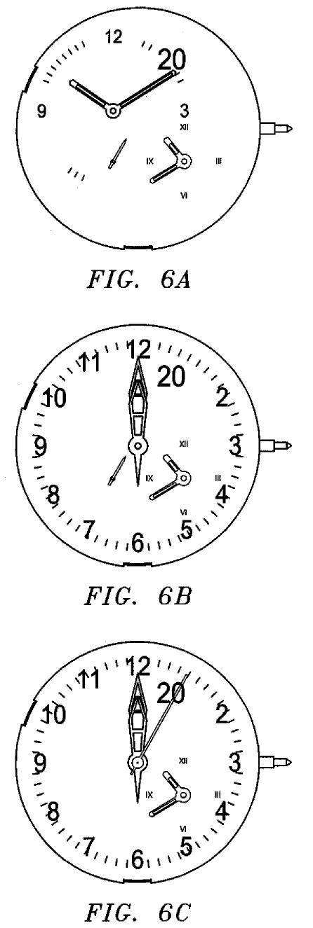

Likewise, FIGS. 6A, 6B and 6C illustrate a time telling, a time zone/alarm time and date display configuration, which would also typically require a minimum of four motors.

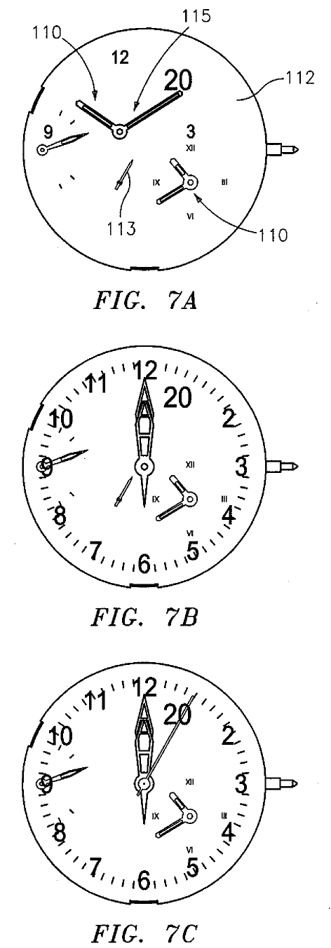

Combining still more of the aforementioned features, FIGS. 7A, 7B and 7C illustrate time telling, a time zone/alarm time, a date display and a retrograde hand (e.g. a day or month display), which would typically increase the minimum number of motors to five.

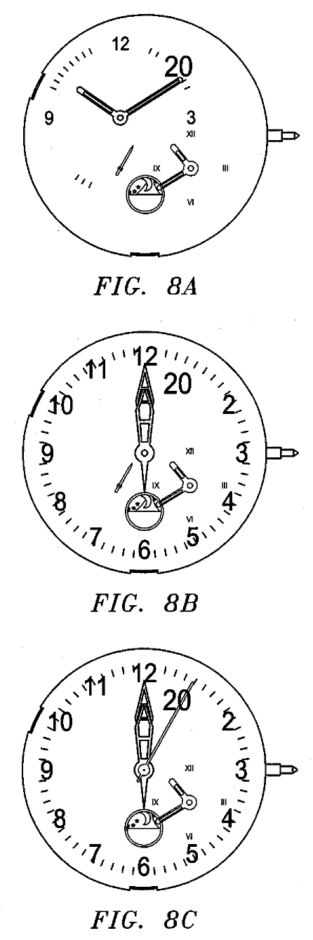

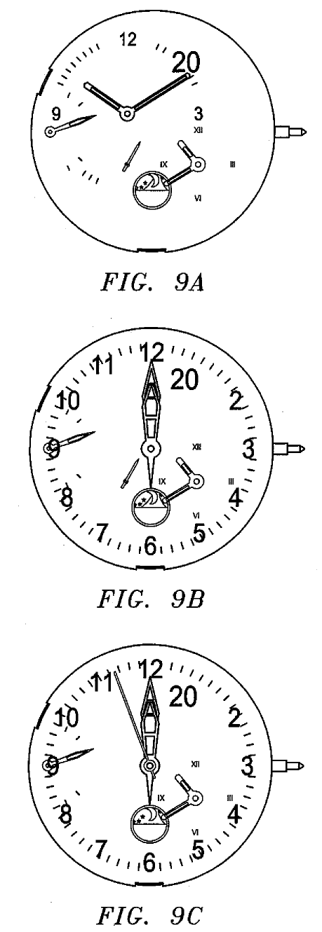

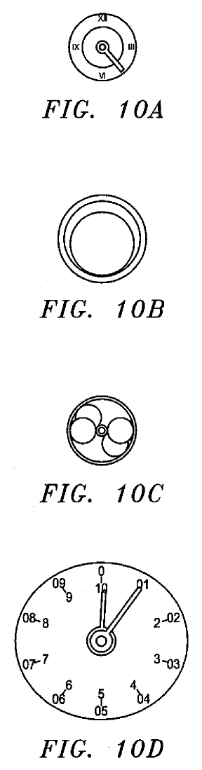

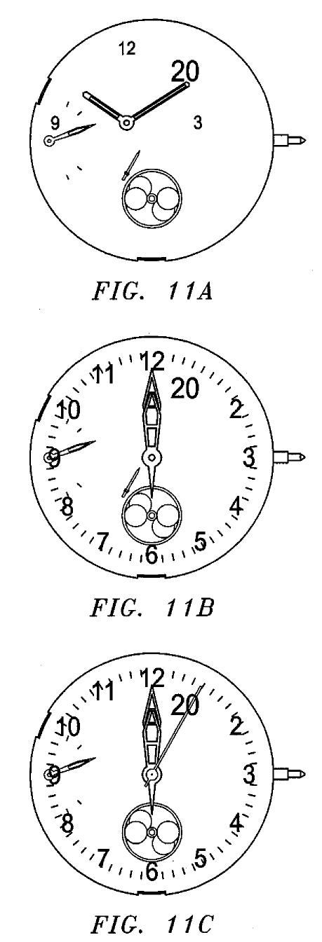

FIGS. 8A, 8B and 8C illustrate four motor examples of a configuration for telling time, providing a second time zone/alarm time (e.g. 24-hour indicator) and a date display, which would typically need four motors, while FIGS. 9A, 9B and 9C illustrate five motor examples of configurations for telling time, providing a second time zone/alarm time (e.g. 24-hour indicator) a date display and a retrograde hand as disclosed above.

Still further as and will be further understood below, variants of a second time zone “eye” are applicable for all styles with a 4-o'clock eye, as illustrated in FIGS. 10A, 10B, 10C and 10D, each of which can be respectively used as a 24-hour display, a tide display, a hemispheric moon phase display and a decade display, by way of example.

FIGS. 11A, 11B and 11C illustrate examples of a wearable electronic device in the form of a wristwatch having a time-telling display, a date display, a retrograde hand for the day or month and a (e.g. 29.5 day) moon phase display. Such configurations would typically require five motors, as should now be understood by one skilled in the art.

Chronographs with four and five motor configurations are also achievable by utilization of the present invention.

Importantly, it should be understood that many of the embodiments through this disclosure could be configured using less (or more) modules than explicitly disclosed. That is, the number of modules and stepper motors may be dictated at least in part by the desired functionality of the device. For example, a secondhand, hour hand and minute hand (e.g. a simple time telling device) could utilize one, two or three motors. Likewise, progressing from a calendar feature in which the hour wheel is directly coupled to the date ring to a device where the hour wheel and the date ring are decoupled would typically increase the number of needed motors, but also simultaneously increase the functionality and versatility of the device as well, and thus, the number of motors/modules called out in some of the embodiments set forth herein are for exemplary purposes and not by limitation.

Still by way of background, some exemplary and overall construction and aesthetic advantages of the present invention provide for a movement of approximately 14-¼ lignes round and approximately 5.9 mm thick. Preferably, many if not all of the exposed surfaces of the movement will be of metal, and may further be gold plated and/or decorated (e.g. Côtes de Genève, perlage, and custom logo treatments). In a preferred embodiment, the movement will weigh approximately 11 grams when configured with all five of its motors. By comparison, it is noted that the Ronda 5000 series 13-½ lignes multifunction movements weigh approximately 11 grams and are 4.4 mm thick, while the Ronda 7000 series 15 lignes big date movements weigh about 29 grams and are 6.0 mm thick.

With some of the more general attributes now disclosed, reference is now made to additional figures in connection with the following for a detailed disclosure of the present invention, including different aspects thereof, including the design and construction of a wearable electronic device constructed in accordance with the present invention.

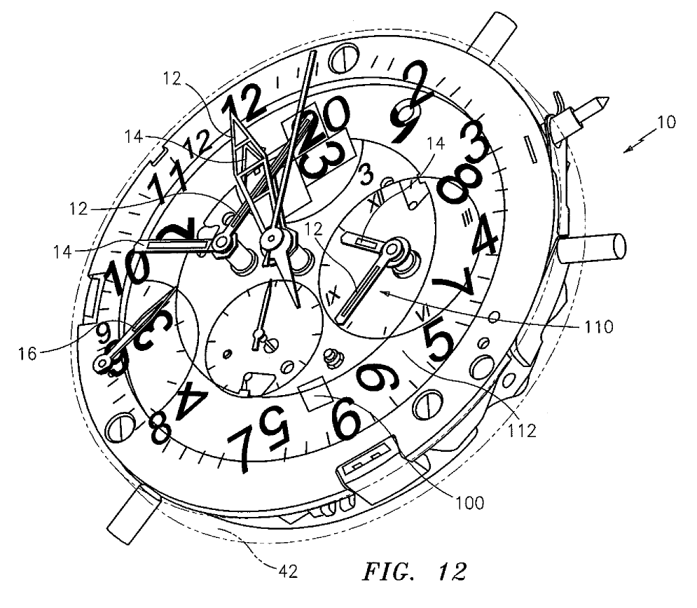

For example, reference is thus generally made to the figures, and in particular FIGS. 12, 20A-20C, 21 and 22A-22D, which illustrate various embodiments of a wearable electronic device, generally indicated at 10, and various embodiments of the module, generally indicated at 50, all constructed in accordance with the present invention.

For example, and in accordance with a first embodiment of the invention, wearable electronic device 10 conveys information using one or more display indicators as disclosed herein. In one preferred embodiment, the electronic device comprises a housing 42; a nest 30 positioned in the housing 42; a plurality of independently insertable and removable modules 50 coupled to the nest 30, wherein each module 50 comprises (i) a gearing arrangement comprising at least one rotateable gear 55 and (ii) a stepper motor 60, the stepper motor 60 comprising a rotor rotateably coupled to the at least one rotateable gear; a controller 100 operatively coupled to the stepper motor 60 of each module 50, for causing the rotation of the rotor of each module 50; wherein each of the plurality of modules 50 has associated therewith and mechanically coupled thereto one or more display indicators (e.g. hands, rings, discs, linear display indicators such as that disclosed in copending application Ser. No. 12/046,947 the subject matter of which is incorporated by reference herein for the purpose of disclosing such a linear display indicator); whereby the positioning of the one or more indicators conveys information by referring to particular indicia (e.g. on the surface of a dial 112).

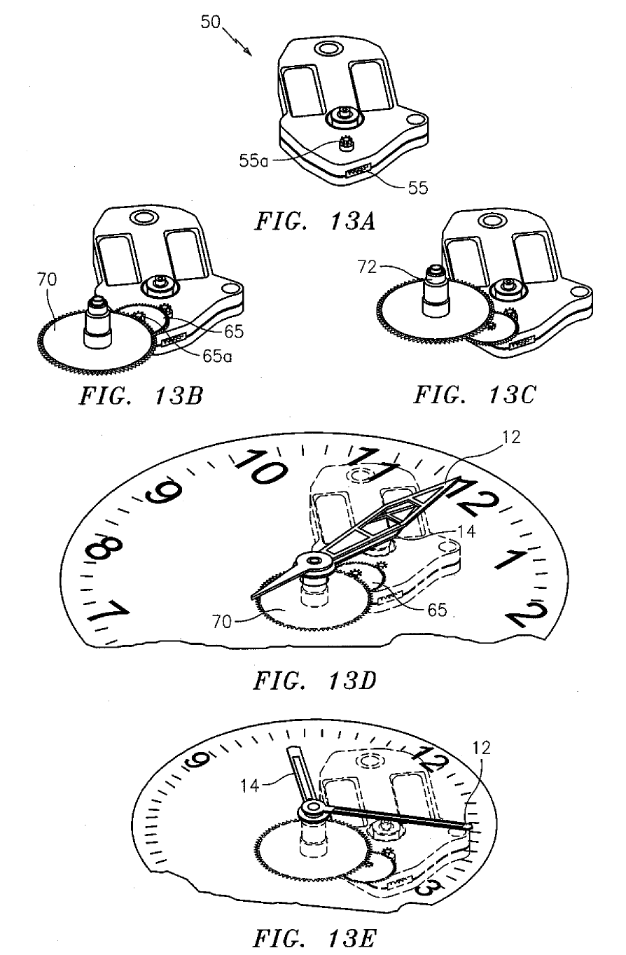

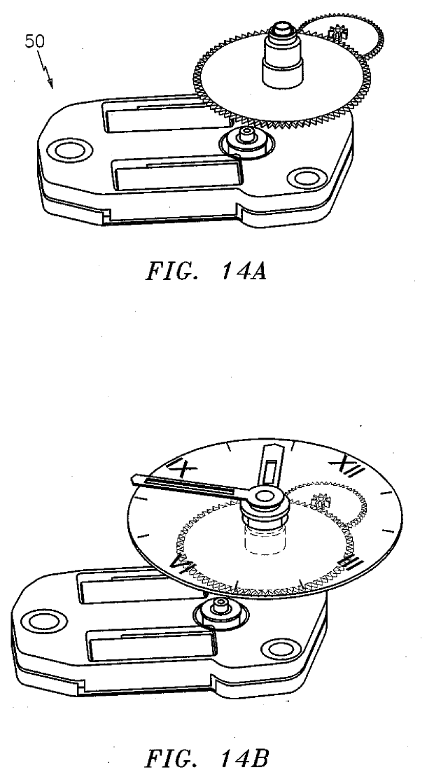

Reference is next made to FIGS. 13A, 13B, 13C, 13D, 13E, all of which illustrate a module 50, constructed in accordance with the present invention. Module 50, in a preferred embodiment, is an exemplary and independently insertable and removable module that will be coupled to the nest 30. As illustrated, module 50 comprises a gearing arrangement comprising at least one rotateable gear (e.g. gear 55) and stepper motor 60. As also illustrated, stepper motor 60 comprises a rotor rotateably coupled to the at least one rotateable gear 55.

In the example of FIGS. 13A-13E among others as well, stepper motor 60 is preferably a bi-directional motor most easily configured for “time telling.” As such FIGS. 13A-13E illustrates how module 50 is configured for driving a main minute hand 12 and an hour hand 14. Specifically, wheel 65 meshingly engages a pinion 55a of wheel 55. In turn, a pinion 65a of wheel 65 meshingly engages wheel 70, in a manner to rotate hands 12, 14 as would be well understood in the art.

Advantageously, it can be seen that a simple (re)positioning of wheel 70 provides for the minute and hour hands to be centered (e.g. FIG. 13D) or off-centered (e.g. FIG. 13E).

As such, it can be seen that the wearable electronic device may comprise at least a first module being associated with at least a first stem 72, wherein the at least one rotateable gear 55 of the first module is rotateably coupled to its associated first stem (e.g. via wheels 65, 70); and the at least one or more display indicators (e.g. hands 12, 14) associated with the first module is mechanically coupled to the first stem.

In yet an alternative embodiment, module 50 may be configured for use in connection with a 2nd Time Zone or other similar functional configuration. For example, FIGS. 14A and 14B illustrate module 50 being used in connection with the driving of a second time zone minute and hour hand. Here, a wheel arrangement, as would be understood in the art, may be used to drive the minute and hour hands 12, 14. Thus, it can also be seen that in a preferred embodiment, each module of the plurality of modules is associated with at least a respective stem, wherein the at least one rotateable gear of each respective module is rotateably coupled to its associated respective stem; and the at least one or more display indicators associated with each module is mechanically coupled to its associated respective stem. That is, in a device having for example, only normal time-telling and a second time zone as constructed herein, each of the modules would be associated with a stem and gear arrangement as disclosed herein.

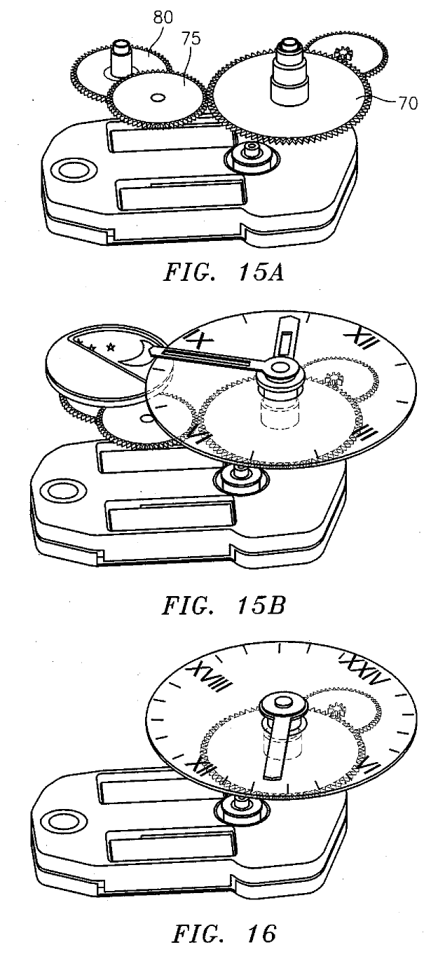

In still a further variation, FIGS. 15A, 15B illustrate the use of module 50 being used in connection with a second Time Zone (2-hand variation) with additional wheels 75, 80 being meshingly coupled to wheel 70 for the display of the sun and moon (12/24) function.

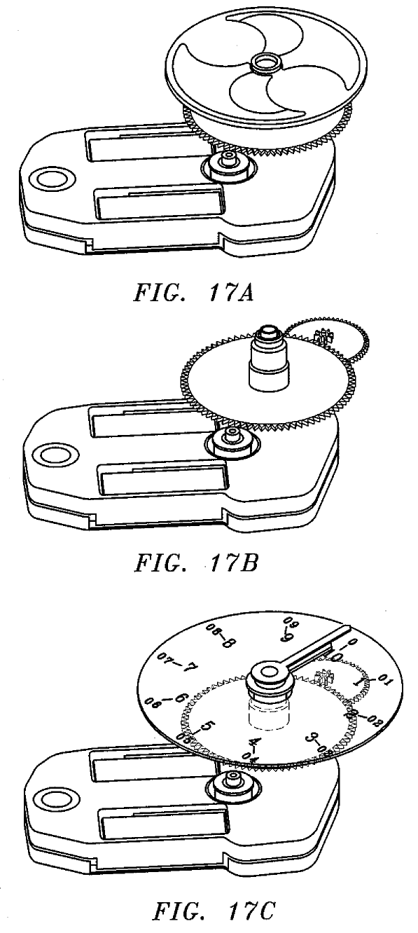

Alternatively and as illustrated in FIG. 16, module 50 may be easily adapted for use in connection with a second Time Zone, but with only a single hand (e.g. 24 hour) display. FIGS. 17A, 17B, 17C illustrate module 50 being used in connection with other configurations, such as for a North/South hemisphere true moon phase display (FIG. 17A) or for a decade counter (FIGS. 17B, 17C).

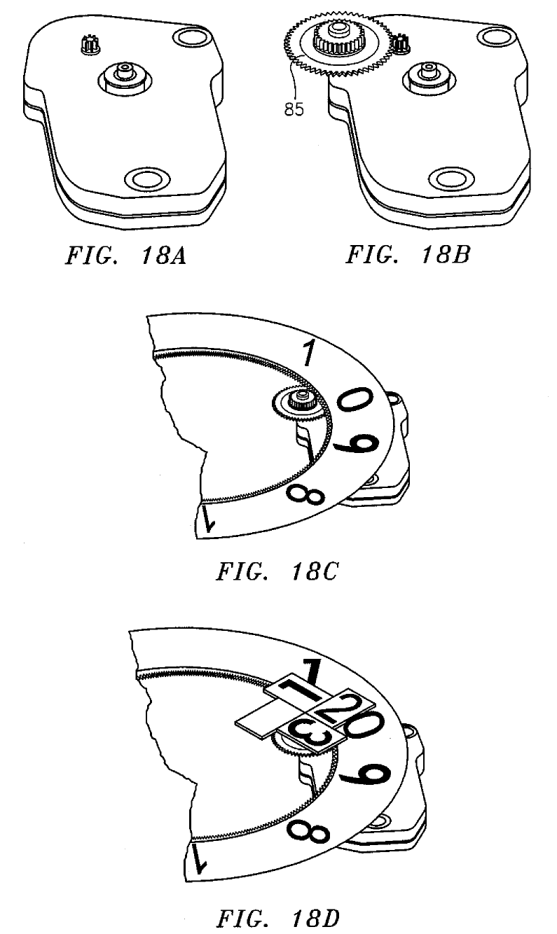

In still another embodiment, module 50 as illustrated in FIG. 18A may be used for driving the date rings/disc of FIGS. 18C, 18D in a manner disclosed in Publication No. US2006/0285445 and incorporated by reference herein, and therefore a wheel 85 is provided therefor (see FIG. 18B). As can thus be seen, a specific embodiment provides that at least one of the at least one or more display indicators may be mechanically coupled to the gearing arrangement of at least one of the modules. For example, the at least one display indicator is a ring, such as a date ring.

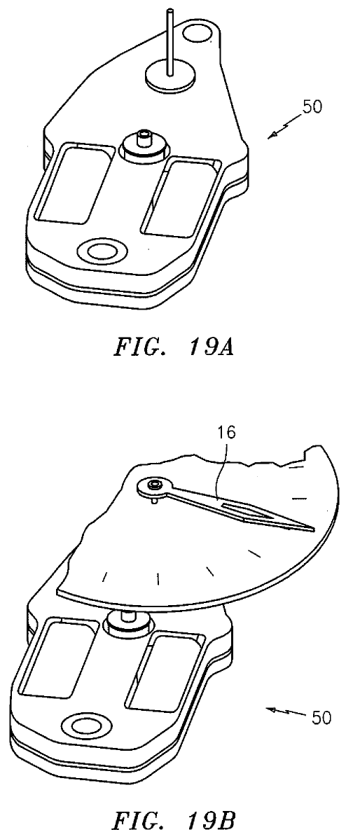

In yet another example of the present invention as illustrated in FIGS. 19A, 19B, module 50 may be used for driving one or more other display hands, such a hand 16, which is also illustrated in FIG. 12 at the 9:00 o'clock position. Here the pinion on which display hand is positioned may be directly coupled to a gear of module 50.

The present invention provides advantages and achieves objectives heretofore not found in the prior art. For example, along with those advantages and objectives set forth above, the present invention provides for new and further innovative designs, many if not all of which will be achievable with lower power consumption and/or smaller profiles. In addition, the present invention provides for and anticipates the use of metal parts as well as plastic functional parts. In addition, all the stepper motors in the wearable electronic device can be controlled by a single processor, details of which will be disclosed below.

However, reference is first made to yet additional figures for the disclosure of other aspects of the present invention, namely the assembly of preferred embodiments.

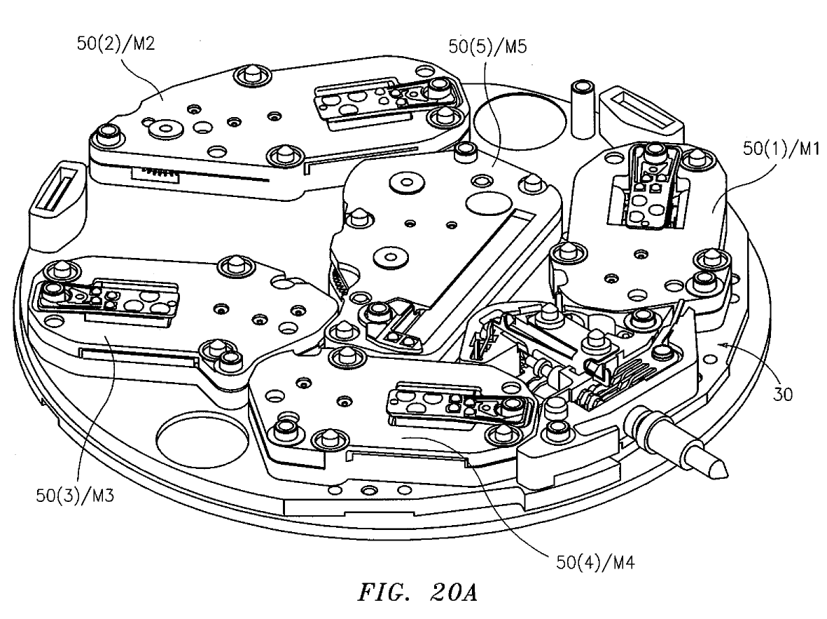

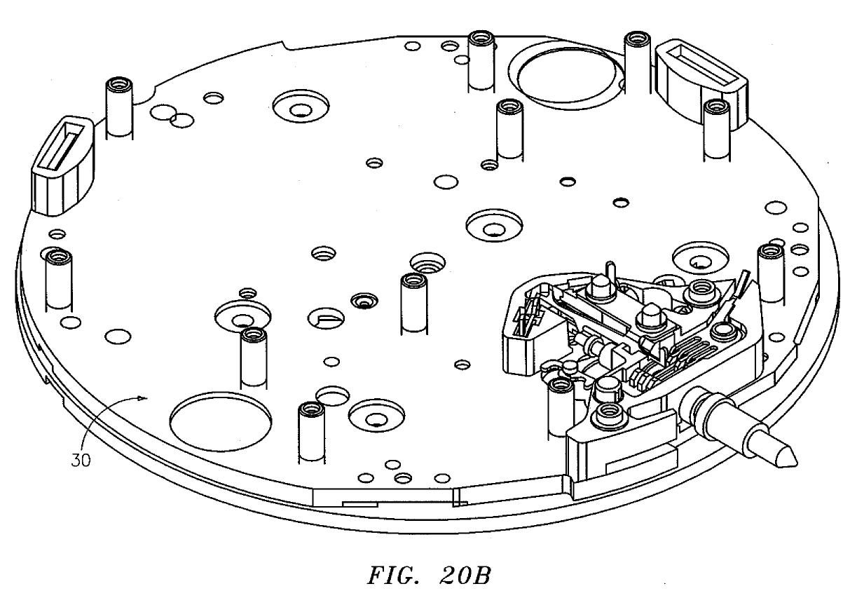

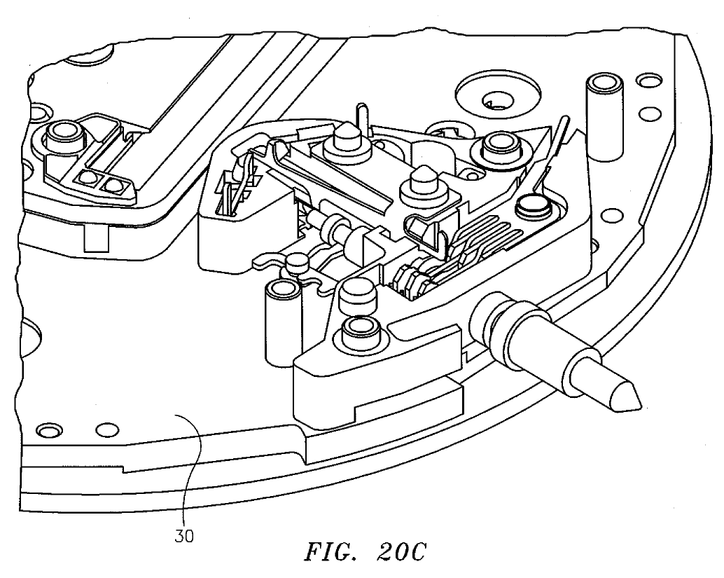

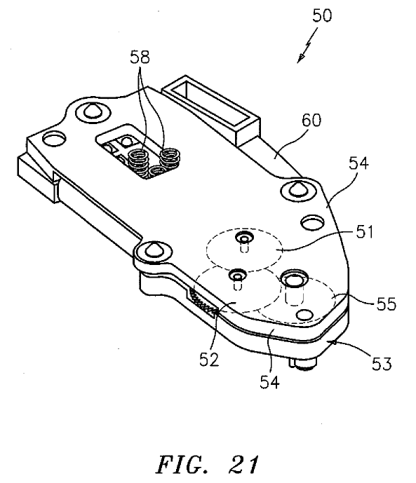

As mentioned above, the present invention preferably uses a metal frame, generally indicated at 30 and also referred herein as a “nest” in FIGS. 20A-20C. In the preferred embodiments, nest 30 is provided to hold, among other things, modules 50. In the preferred embodiments and as shown in FIG. 21, modules 50 utilize plastic frames 53 and bridges 54 for all of the intricate high-tolerance positioning needed for modern low power Quartz Analog movements. It can thus be seen that the frame 53 and bridge 54 encapsulate at least part of the stepper motor and gearing arrangement; whereby insertion into and removal from the housing of the module as a unit is facilitated by virtue of the fact that the modules can be insertable and removable as a unit.

As will now be appreciated, a preferred gear train so that the rotation of the rotor of stepper motor 60 rotates wheel 55 may be accomplished by having the rotor of stepper motor 60 meshingly engaged with wheel 51. Wheel 51 includes a pinion (not shown) that is meshingly engaged with a wheel 52. Wheel 52 includes a pinion (not shown) that is meshingly engaged with wheel 55. FIG. 21 also illustrates that each module 50 provides external (top) electrical connection points (metal spring contacts 58) as well as power take off (PTO) drive shafts appropriate to the module's functions.

Advantageously and as one of the objectives of the present invention, modules 50 can be fully formed, assembled and tested in one factory and shipped to another factory as desired or necessary as sub-assemblies, which can then be “dropped into” metal nest 30, possibly with no further required testing.

As will now also be understood, there are generally three (3) types of modules, each providing different functional capabilities ranging from simple time-telling (3-hand uni-directional motor and gear train) to multifunctional bi-directional systems for linear indicators, turning disks, instrument readouts, etc.

Also in the preferred embodiment, it is contemplated that the metal nest 30 be constructed as a generic frame/nest with positions available for multiple modules 50, although it is contemplated that population of only as many modules as one needs for a particular configuration will be carried out. This too ensures as wide a multifunctional approach as possible.

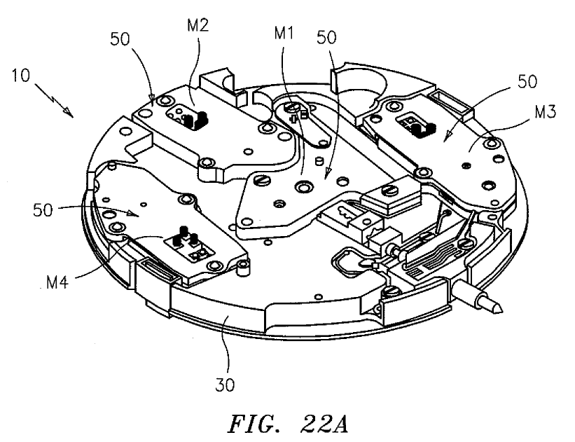

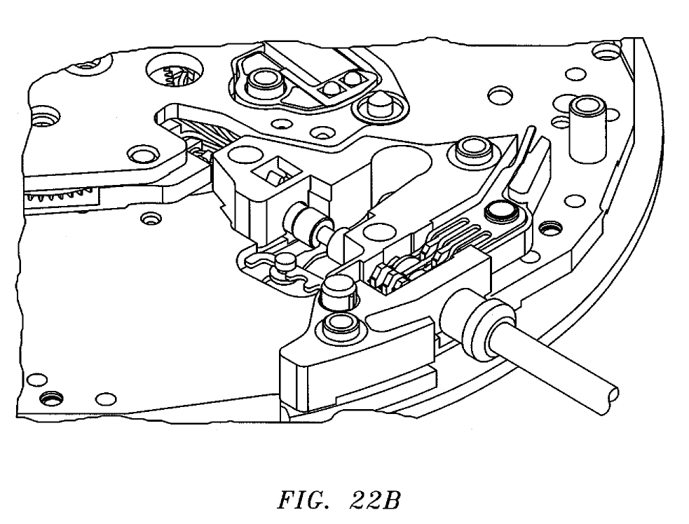

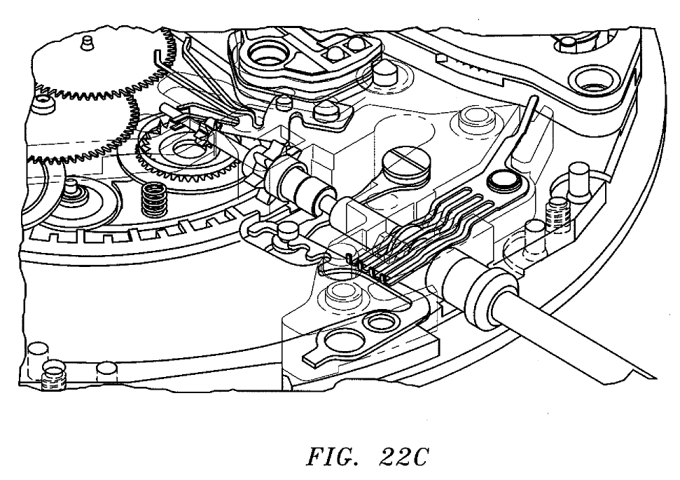

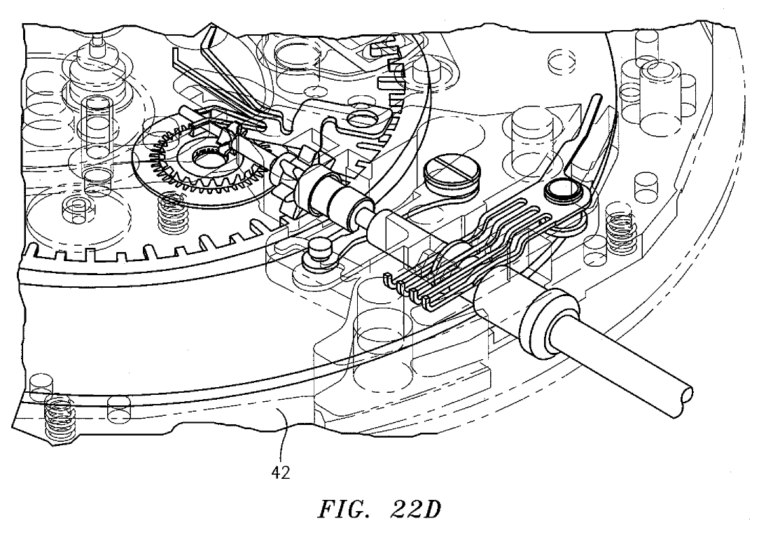

For example, FIGS. 22A, 22B illustrate a four module embodiment with a 5^{th} mechanical setting module, each of which is consistent with the foregoing, comprising at least one actuation mechanism (e.g. stepper motor) and one or more gears rotatably engaged with the actuation mechanism, wherein actuation of the actuation mechanism causes the rotation of the one or more gears.

In FIG. 22A each respective stepper motor of each of the four modules 50 are, for convenience, designated generally in the figures as M1, M2, M3 and M4. As would be understood in the art, their specific location is one of design choice and dictated by constraints such as spacing, power and torque requirements. As positioned in the housing and on nest 30, motor M3 may be provided to rotate, via a gear/wheel assembly, the second timezone display hands 12, 14 at the 4:00 o'clock position, shown by example in FIG. 12 or an alternative display hand 13 shown in FIG. 28. Likewise, motor M4 is positioned to rotate, via a gear wheel train, a display hand 16 the exemplary configuration of FIG. 12 or a display hand 17 shown in FIG. 28 in a similar manner. With the present invention thus constructed, various display hands (or rings, discs as the case may be) and/or other display assemblies can be provided thereon.

It is believed that the foregoing embodiments, in combination with the teachings of U.S. Pat. No. 7,113,450 and Published Application No. US2007/0008823, the subject matter of which is incorporated by reference for its exploded view disclosure and figures related to the construction of a device in which the stepper motors are ultimately coupled to their respective pinions and display hands, more than adequately discloses and teaches how to construct a wristwom electronic device of the present invention. However, for completeness, it should now be appreciated that motor M1 in FIG. 22A may be positioned to rotate a center hour and minute hand in a known manner (e.g. being coupled via a gear train for conveying the rotational activity generated by the rotor of motor M1), while a fourth hand (e.g. hand 19 in FIG. 28), the particulars and advantages thereof being set forth in greater detail in the aforementioned '450 Patent, may be controlled by stepper motor M2 via its own associated gear train. Again, it is believed that the construction of these respective gear trains are also well within the purview of one ordinarily skilled in the art.

In such a specific preferred embodiment, at least motors M3 and M4 (and preferably M2) of the respective modules 50 are bi-directional stepper motors thus being able to rotate in either direction, and the construction of acceptable stepper motors to functionally operate in this manner are widely available and well within the understanding of those skilled in the art. Motor M1 need not be bi-directional as would be known to one skilled in the art if it were merely for rotating hour and minute hands, although it may be preferable that motor M2 is bi-directional as well.

In the electroset embodiment of FIG. 20A, which illustrates a 5 motor embodiment, reference may be had to FIG. 7A by way of example and not limitation for yet another exemplary configuration. Here, each respective stepper motor of each of the five modules 50 are, for convenience, designated generally in the figures as M1, M2, M3, M4 and M5. Likewise, as would be understood in the art, their specific location is also one of design choice and dictated by constraints such as spacing, power and torque requirements. As positioned in this exemplary housing and on nest 30, motor M1 may be provided to rotate, via a gear/wheel assembly and/or ring assembly, the calendar feature of FIG. 7A. Motor M2 is positioned to rotate, via a gear wheel train, the display indicator at the 9:00 position, motor M3 is positioned to rotate the hour and minute hand assembly 115, motor M4 is positioned to rotate the hour/minute display at the 4:00 o'clock position (e.g. a second time zone) and motor M5 is positioned in the exemplary embodiment of FIG. 20A to rotate the second hand designated by reference number 113. Again, with the present invention thus constructed, various display hands (or rings, discs as the case may be) and/or other display assemblies can be provided thereon.

However, as mentioned above, the position of the modules and/or the position of the display indicators can be moved and/or repositioned merely by providing additional gears, as would now be understood by the present disclosure.

A plurality of different display assemblies, generally indicated at 110 in FIG. 12 and 7A, thus illustrate a plurality of display indicators above a Mylar or other suitable plastic dial 112. As such, dial 112 may have thereon surface indicia, corresponding to the various displays and modes, printed, silk-screened or otherwise formed thereon. Again, the various displays disclosed herein and in the aforementioned U.S. Patents, namely the '450 patent, incorporated herein by reference, provide examples of other indicia that may be advantageously provided to appreciate the present invention. Obviously, time-telling indicia may also be provided on dial 112 to assist in telling time.

As should be appreciated by one skilled in the art, the location/position of these display hands are merely dictated, for example, by the position of the pins carrying the hands and the position of the respective modules 50. Thus, the particular locations of the second time zones and/or display hands in the figures are shown by example and not limitation.

To be sure however, the present invention may also be provided with one or more different displays, such as a ring or disc, as disclosed above and examples of which are also disclosed and discussed in U.S. Pat. Nos. 7,423,936; 7,120,091 and/or Published Application Serial No. US2007/0008823, the subject matter of which are also incorporated herein by reference for this purpose of disclosure. As would thus be understood, the Mylar dial may also have one or more windows through which the rings/discs are visible, as disclosed in the foregoing cited documents.

The gearing ratio to provide for the desirable display rotation or movement of the display hands or discs/rings would be one of design choice depending on the desired or required incremental rotation of the display indicators. Thus the number of wheels in any particular gearing assembly may be more or less than that disclosed herein, and are really one of design choice for the intended function and based upon a number of criterions known to the ordinary designer.

It can thus be seen that the present invention can accommodate one or more differing display indicators (e.g. hands, rings and/or discs). Importantly, the controlling of the respective indicators may require differing controlling functionality.

A controller provides the proper and accurate controlling, positioning and rotation of hands on the one hand, and discs on the other, and it should be appreciated that differing controlling may be needed for the particular mode/display being provided (i.e. controlling a hand for an altimeter is quite different than for a lap counter or time zone indicator). Details of a generic controller for controlling such display assemblies can be found in the aforementioned U.S. Pat. No. 7,113,450, the subject matter of which is incorporated herein by reference for this purpose, and the controller of the present invention preferably comprises all of the functional features described therein to carry out the objectives and features of the present invention. However, to ensure completeness, the following is provided.

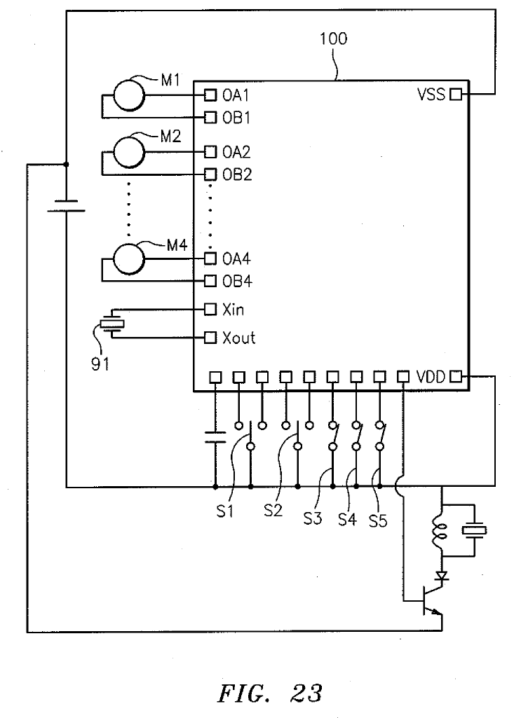

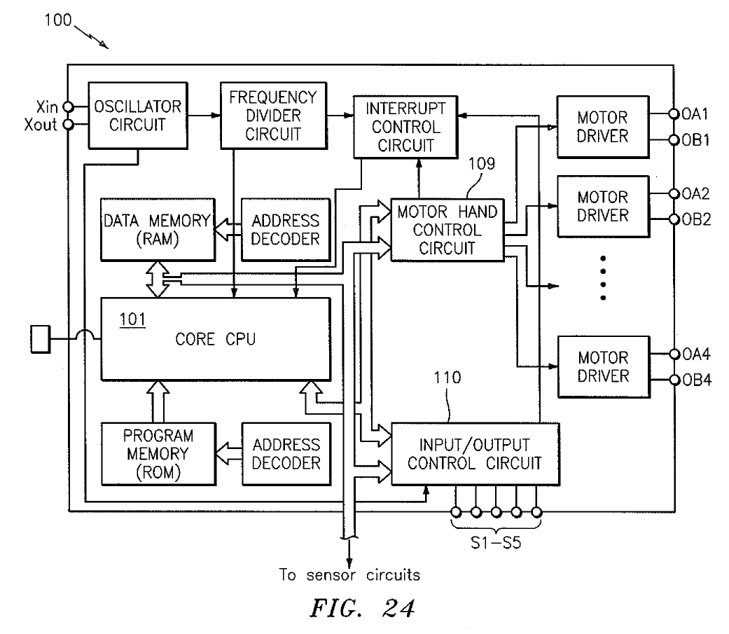

General reference may thus be made to FIGS. 23 and 24 for partial block diagrams of the electronic device of the present invention, which illustrates among other things, interface connections to motors M1, M2, M3 and M4 of modules 50. Obviously, the controller would similarly accommodate a fifth (or additional) motor M5 in a similar way, even though it not specifically illustrated in the block diagram. Switches S1-S5 are intended to generically indicate both side/top mounted pushers, as well as side mounted rotatable crowns, and thus respond to the actuation (i.e. pulling and/or pushing) action thereof. In the case of crowns, the pulling and or pushing actuations may be provided for setting hands 18, 20 and/or calibrating, such as hands 24, 26 on the one hand and discs, if provided. A preferred hand and disc calibration methodology and arrangement is disclosed in the aforementioned '450 Patent and U.S. Pat. No. 7,266,051 the subject matter which is likewise incorporated by reference as if fully set forth herein. In this way, it is always possible to calibrate (i.e. initialize the position of) the hands and rings so that controller 100 knows their respective positions. An input/output control circuit 110 controls the crown actuations and pushbutton switches and provides such signaling information to CPU 101.

Reference may thus be made to motor control circuit 109, which receives a commanded “next number of pulses” from CPU core 101 and generates the pulsed and phased signals necessary to move a desired motor (M1, M2, M3, M4) a desired amount and in a desired direction. Pulse outputs of motor control circuit 109 are buffered by motor drivers MD1, MD2, M3, and MD4 and applied to respective motors M1, M2, M3, M4.

By appropriate configuration and programming of controller 100, it is thus possible to ensure that the functionality and operation of controller 100 adjusts for the particular display indicator of the particular display assembly as well as for the particular gear train associated with each module 50. Thus, controller 100 can be customized or changed to adjust to properly control the particular display indicators. Thus, controller 100 can coordinate and control the display of any parameter of other information with hands, discs or other assemblies.

Reference can also be made to the '450 Patent for a more detailed description of the circuit composition and/or hand control features and elements to interface electronic device 10 to “the outside world.” By way of example and not limitation, some of the sensor circuits for measuring external parameters applicable in the present invention are ambient temperature, altitude and water depth, body temperature, heart rate, blood pressure and compass headings, just to name a few.

Although the preferred embodiment provides that controller 100 is highly integrated wherein all timing and display functionality is controlled in controller 100, alternate embodiments could separate the timekeeping functions from those processing and displaying stored or sensed data, as would be understood by one skilled in the art.

Again, proper microcontroller codes and/or other programming functionality allow for the customization and changing of the controller to be properly configured to accurately control the display indicators, regardless of their type or position on nest 30, and the '450 Patent provides an excellent description of particular examples of displaying information using a display indicator using stored, sensed or transmitted data.

All of the foregoing thus provides that the display functionality of the wearable electronic device is changeable based on the display assembly to be operatively coupled to the one or more gears in the housing and whereby the modules and subassemblies can be used to provide differing display functionality based on the display assemblies coupled thereto.

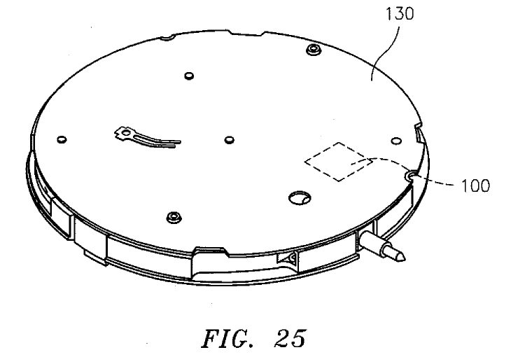

As illustrated in FIG. 25, a printed circuit board 130 containing all of the electronic components including controller 100 for the particular version of the electronic device may be placed over modules 50 and screwed down (for simplicity, FIG. 25 omits many of the actual electronic components).

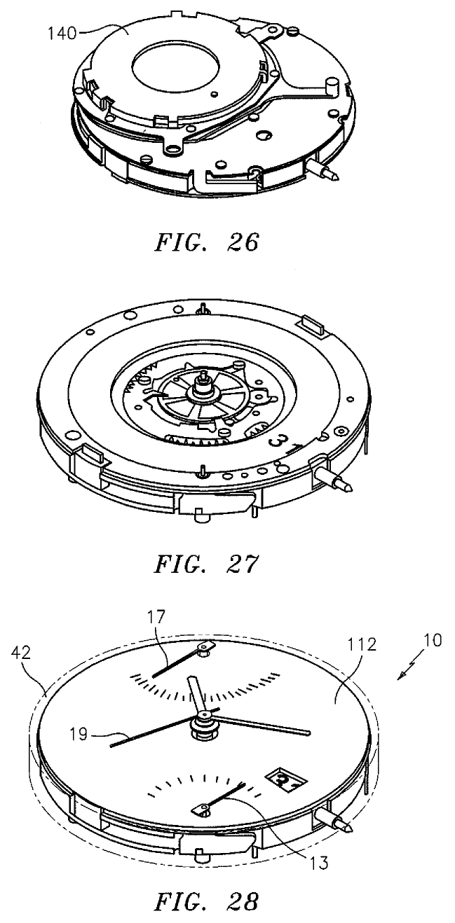

Thereafter, the caseback side of the movement is ready for a battery 140 as illustrated in FIG. 26 In practice, it is preferable to add a metal cover for any exposed portions of the printed circuit board that may be positioned adjacent battery 140.

Next, the preferred assembly sequence provides for the addition of the discs, wheels, linear indicators, and/or any other components needed for the complete movement, which is exemplified by FIG. 27 (as well as FIGS. 1-8 illustrated in Published Application No. US2007/0008823, the disclosure of which is incorporated by reference herein for this purpose).

Lastly, dial 112 and the hands, as the case may be, may be provided to create a “fit-up,” as illustrated in FIG. 28. The crystal and other features may thereafter be added to complete the wearable electronic device.

With the above in mind, it is believed that the present invention has been thoroughly disclosed so as to construct the wearable electronic device as illustrated in the above figures, including a comprehensive version with multiple modules 50, as disclosed herein. As such, it is believed that those skilled in the art would know how to incorporate additional components, such as any remaining metal components with studs and center posts, a crown assembly, a PCB assembly, the battery, any decorative features, any/all date rings and/or holding plates, etc.

It will thus be seen that the objects set forth above, among those made apparent from the preceding description, are efficiently attained and, since certain changes may be made in the above constructions without departing from the spirit and scope of the invention, it is intended that all matter contained in the above description or shown in the accompanying drawings shall be interpreted as illustrative and not in a limiting sense.

It should also be understood that the following claims are intended to cover all of the generic and specific features of the invention described herein and all statements of the scope of the invention that as a matter of language might fall therebetween.

What is claimed is:

1. A wearable electronic device for conveying information using one or more display indicators, wherein the electronic device comprises:
a housing;
a nest positioned in the housing;
a plurality of independently insertable and removable modules coupled to the nest, wherein each module comprises (i) a gearing arrangement comprising at least one rotateable gear and (ii) a stepper motor, the stepper motor comprising a rotor rotateably coupled to the at least one rotateable gear;
a controller operatively coupled to the stepper motor of each module, for causing the rotation of the rotor of each module;
wherein each of the plurality of modules has associated therewith and mechanically coupled thereto one or more display indicators;
whereby the positioning of the one or more indicators conveys information by referring to particular indicia.

2. The wearable electronic device as claimed in claim 1, wherein:
at least a first module of the plurality of modules is associated with at least a first stem, wherein the at least one rotateable gear of the first module is rotateably coupled to its associated first stem; and
the at least one or more display indicators associated with the first module is mechanically coupled to the first stem.

3. The wearable electronic device as claimed in claim 1, wherein:
each module of the plurality of modules is associated with at least a respective stem, wherein the at least one rotateable gear of each respective module is rotateably coupled to its associated respective stem; and
the at least one or more display indicators associated with each module is mechanically coupled to its associated respective stem.

4. The wearable electronic device as claimed in claim 1, wherein at least one of the at least one or more display indicators is mechanically coupled to the gearing arrangement of at least one of the modules.

5. The wearable electronic device as claimed in claim 3, wherein: the at least one display indicator is a ring.

6. The wearable electronic device as claimed in claim 4, wherein: the at least one display indicator is a ring.

7. The wearable electronic device as claimed in claim 1, wherein the electronic device comprises a dial having a dial side and an opposing side and surface indicia visible from the dial side to which the one or more of the display indicators can point and convey information thereby, wherein the gearing arrangement and the stepper motor of each module is positioned on the opposing side of the dial, and the controller is also positioned on the opposing side of the dial, wherein the display indicator is positioned on the dial side of the dial and moves linearly, and wherein the display indicator conveys information by referring to particular surface indicia on the dial.

8. The wearable electronic device as claimed in claim 1, wherein the electronic device comprises a dial having a dial side and an opposing side and surface indicia visible from the dial side to which the one or more of the display indicators can point and convey information thereby, wherein the gearing arrangement and the stepper motor of each module is positioned on the opposing side of the dial, and the controller is also positioned on the opposing side of the dial, wherein the display indicator is rotatable in at least one of a clockwise and counterclockwise direction; wherein the display indicator is positioned on the dial side of the dial and wherein the display indicator conveys information by referring to particular surface indicia on the dial.

9. The wearable electronic device as claimed in claim 8, wherein the at least one display indicator is a display hand.

10. The wearable electronic device as claimed in claim 1, wherein at least one of the plurality of modules comprise a frame and a bridge for encapsulating at least part of the stepper motor and gearing arrangement; whereby insertion into and removal from the housing of the module as a unit is facilitated.

11. The wearable electronic device as claimed in claim 1, wherein each of the plurality of modules comprise a frame and a bridge for encapsulating at least part of each respective stepper motor and gearing arrangement; whereby insertion into and removal from the housing of each respective module as a unit is facilitated.

12. The wearable electronic device as claimed in claim 1, wherein the nest is comprised of metal.

13. The wearable electronic device as claimed in claim 1, wherein the wearable electronic device is a wristwatch.

14. A method of manufacturing a wearable electronic device for conveying information using one or more display indicators, comprising the steps of:
assembling, in a first manufacturing location, a plurality of independently insertable and removable modules, each of which comprise (i) a gearing arrangement comprising at least one rotateable gear and (ii) a stepper motor, the stepper motor comprising a rotor rotateably coupled to the at least one rotateable gear;
transporting the assembled independently insertable and removable modules to a second location;
constructing the electronic device by at least performing the steps of:
inserting the assembled independently insertable and removable modules into a housing and positioning the modules onto a nest;
operatively coupling a controller to the stepper motors of each module, for causing the rotation of the rotor of each module;
operatively coupling each of the plurality of modules to at least one display indicator, wherein the positioning of the one or more indicators conveys information by referring to particular indicia.

15. The method as claimed in claim 14, including the step of positioning a printed circuit board 130 containing additional electronic components for operation of the electronic device into the housing and over the modules.

16. The method as claimed in claim 15, including the step of positioning a battery in the housing and providing a cover to assist in protecting the printed circuit board.

17. The method as claimed in claim 16, including the step of positioning a printed circuit board 130 containing additional electronic components for operation of the electronic device into the housing and over the modules.
